(19) United States
(12) Patent Application Publication
(10) Pub. No.: US 2019/0291883 A1
(43) Pub. Date: Sep. 26, 2019

(54) FLYING VEHICLE EMERGENCY PROCEDURES

(71) Applicant: Hoversurf, Inc., Burlingame, CA (US)

(72) Inventor: Aleksandr ATAMANOV, St. Petersburg (RU)

(73) Assignee: Hoversurf, Inc., Schweinfurt (DE)

(21) Appl. No.: 15/926,841

(22) Filed: Mar. 20, 2018

(51) Int. Cl. B64D 31/10; B64C 27/00; B64C 27/08; B64C 27/12; B64C 27/57; B64D 31/12; B64D 45/00

(52) U.S. Cl. CPC B64D 31/10; B64C 27/006; B64C 27/08; B64D 2045/0085; B64C 27/57; B64D 31/12; B64D 45/00; B64C 27/12

(57) ABSTRACT

A system and method for operating a flying vehicle that includes a vehicle having a plurality of motors, each of said motors coupled to a rotor and a motor controller; at least one sensor coupled to either the plurality of motors or the rotors, said sensor operative to sense an operating characteristic of the rotor or motor based on a predetermined setpoint; a processor, said processor coupled to a memory and to said motor control circuitry and said sensors, said processor operable to; receive a signal from the sensor; determine a predetermined operational procedure in response to the signal, and alter the operating characteristics of one or more motors, wherein the signal indicates a failure condition and the operational procedure effects mitigation of the failure condition by removing power to certain motors and increasing power to others.

### BACKGROUND

The invention relates to the field of aviation, namely, to flying vehicles (FV) for vertical take-off and landing (or “multicopter”). A multicopter, also called a multi-rotor helicopter or, in cases with four rotors, a quadrotor, is a helicopter that is lifted and propelled by more than one rotors. Conventionally, four or more rotors are used to increase stability and mobility. Multicopters are classified as rotorcraft, as opposed to fixed-wing aircraft, because their lift is generated by a set of vertically oriented propellers (rotors) instead of airflow across a wing.

Multicopters generally use identical fixed pitched propellers, but operating in tandem to increase stability. For example, counter-rotation increases stability by operating two clockwise and two counterclockwise rotating propellers. Conventionally, independent variation of the speed of each rotor is employed to achieve control. By changing the speed of each rotor it is possible to specifically generate a desired total thrust; to locate for the center of thrust both laterally and longitudinally; and to create a desired total torque, or turning force.

Multicopters differ from conventional helicopters, which use rotors that are able to vary the pitch of their blades dynamically as they move around the rotor hub. Torque-induced control issues, as well as efficiency issues originating from the tail rotor, which generates no useful lift, but requires energy, can be eliminated by counter-rotation, and the relatively short blades may make it easier to build.

Recent advances in electronics allowed for the production of affordable, lightweight flight controllers, accelerometers (IMU), global positioning system and cameras. This resulted in the multicopter configuration becoming popular for small unmanned aerial vehicles. Accordingly, multicopters are cheaper and more durable than conventional helicopters owing to their mechanical simplicity. Their smaller blades are also advantageous because they possess less kinetic energy, reducing their ability to cause damage and making the vehicles safer for close interaction. However, as size increases, fixed propeller multicopters develop disadvantages over conventional helicopters because increasing blade size increases their momentum. This means that changes in blade speed take longer to effectuate, which negatively impacts control. Conventional helicopters do not experience this problem as increasing the size of the rotor disk does not significantly impact the ability to control blade pitch.

### SUMMARY

Disclosed herein are systems and methods for operating a flying vehicle that includes a vehicle having a plurality of motors, each of said motors coupled to a rotor and a motor controller; at least one sensor coupled to either the plurality of motors or the rotors, said sensor operative to sense an operating characteristic of the rotor or motor based on a predetermined setpoint; a processor, said processor coupled to a memory and to said motor control circuitry and said sensors, said processor operable to; receive a signal from the sensor; determine a predetermined operational procedure in response to the signal, and alter the operating characteristics of one or more motors, wherein the signal indicates a failure condition and the operational procedure effects mitigation of the failure condition.

Various sensors may be employed, together with different power sources to effectuate emergency flying procedures in the event a malfunction in a rotor, motor or motor controller. Setpoints for the sensors may be preprogrammed to effectuate detection of failure events, or in some embodiments, serve as precursors to abnormal situations. The operational procedures may be selected depending on the sensor input and put into operation in a manner to counter-act the anticipated results of the failure condition.

The construction and method of operation of the invention, however, together with additional objectives and advantages thereof will be best understood from the following description of specific embodiments when read in connection with the accompanying drawings and claims.

### BRIEF DESCRIPTION OF THE DRAWINGS

FIG. 1 shows a functional block diagram of a first embodiment of certain aspects of a flying vehicle according to the current disclosure.

FIG. 2 illustrates a flowchart illustrating steps that may be used in certain embodiments of the present disclosure.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system, or sensors, and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor(s) contemplates that the methods disclosed herein will also operate over a network such as the Internet, and may be effectuated using combinations of several processing devices, memories and I/O. Moreover any device or system that operates to effectuate techniques according to the current disclosure may be considered a server for the purposes of this disclosure if the device or system operates to communicate all or a portion of the operations to another device.

The processing system may include communications devices such as a wireless transceiver. These wireless devices may include a processor, memory coupled to the processor, displays, keypads, WiFi, Bluetooth, GPS and other I/O functionality. Alternatively, the entire processing system may be self-contained on a single device in certain embodiments.

### System Components

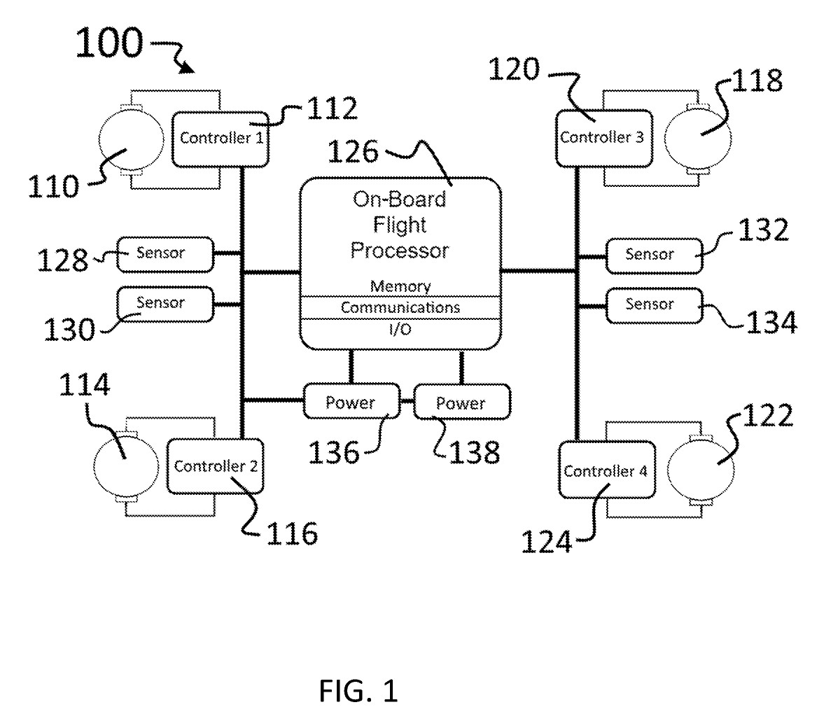

FIG. 1 shows a functional block diagram of a first embodiment of certain aspects of a flying vehicle according to the current disclosure. In FIG. 1 a flying vehicle represented as having four motors 110, 114, 118, and 124, each attached to a motor controller 112, 116, 118, and 124 is shown. The motors are attached to rotors (not shown) and collectively the rotors provide flight and control for the flying vehicle. The controllers 112, 116, 118, and 122 provide variable power to the motors under the control of an on-board flight processors 126.

In certain embodiments, the motors with their respective rotors, are evenly distributed about the center of gravity of a flying vehicle with one pair set diagonally across the center of gravity and another pair set orthogonally to the first set. Note, this disclosure applies to flying vehicles having more than four motors, but four is used herein for illustrative purposes.

To effectuate power usage multiple power source, such as batteries, 136 and 138 may be employed. These power sources may operate independently powering different operations, operate in tandem, or provide power under the control of the on-board flight processor 126.

In some embodiments, the batteries 136 and 138 may be placed in the flying vehicle to effectuate a stable weight distribution. Accordingly, batteries may be effectuated in a package small enough to be hand carried and movable. Conventional battery power sense circuitry may be employed to detect when a battery, or battery pack is losing power. Once sensed the processor may instruct alternative batteries to provide power, in effect, switching the failing batteries out of the circuit and switching in functional batteries. In failure conditions, the processor 126 may switch additional batteries into a circuit. For example, and without limitation, a failure condition might require a process of stopping power to a failing motor and increasing power to operating motor. Accompanying those process steps may be the need to rapidly increase power to the operating motor to quickly return the vehicle to sable flight. This may be accomplished by switching in additional battery power.

The on-board flight processor 126 is coupled to memory, input-output (I/O) devices, and communications systems such as wireless radio, Bluetooth and the like. The wireless communications may include a link for controlling the flying vehicle from a remote operator or, in some embodiments the pre-planned flight may be stored in memory and used by the processor 126 to control flight.

Sensors 128, 130, 132, and 134 are coupled to the on-board flight processor 126. Depending on the nature of these sensors they may also be coupled to one or more of the controllers, the motors power supply, or other electro-mechanical assembly. The types and operation of the sensors may be pre-selected for specific flight characteristics. For example, and without limitation, sensors employed may include:
Vibration sensors for detecting motor vibration
Level sensors for detecting pitch, yaw and roll
Current sensors for detecting current of a motor or motor controller
Back-electromotive force (EMF) sensors for sensing motor operation
Tachometers for sensing speed of motor rotation
Power sensors for sensing power supplied to a motor or controller
Barometers for sensing change in altitude, such as the Precision Micro Barometer Module MS5611 from AMSYS.
Gyroscopes for sensing spin
Accelerometers for sending flying vehicle motion such as those produce by ST Micro, Inc.
Lidar and sonar for measuring distance, especially altitude at close range, but also for detecting close objects during flight.
   To accurately sense meaningful information, the sensors must operate with a high degree of sensitivity, however, the sensitivity of the sensors, the type of sensors, and the quantity of sensors may all be selected on a flight-by-flight basis, thus allowing for a user to set equipment for a desired result. Moreover, each sensor may require information to predetermine whether the sensed parameter is operating within an acceptable range. For example, and without limitation, since vibration is to be expected during flight, the sensor may be pre-adjusted to only indicate when the vibration exceeds a certain setpoint.

A Lidar sensor may be commercially available or easily implemented using conventional technology. As an example “A Low Cost Laser Distance Sensor” by Konolige, Kurt, et al. (2008 IEEE International Conference on Robotics and Automation May 19-23, 2008).

Navigation may be further effectuated using accelerometers and gyroscopes such as those conventionally available by ST Micro, Inc. These devices include 3-axis gyroscopes with sensing structure for motion measurement along all three orthogonal axes—other solutions on the market rely on two or three independent structures.

Conventionally available gyroscopes may be employed to measure angular velocity with a wide range to meet the requirements of different applications, ranging from dead reckoning to more precise navigation. ST's angular rate sensors are already used in mobile phones, tablets, 3D pointers, game consoles, digital cameras and many other devices.

Commercially available motion processing units may also be used to effectuate certain embodiments as disclosed here. For example, and without limitation, the MPU6000 family of devices by TDK, inc. which includes a 3-axis gyroscope and a 3-axis accelerometer on the same silicon die together with an onboard digital motion processor capable of processing complex 9-axis sensor fusion algorithms.

Sensors may provide for direct programming of a setpoint. In which case the sensor outputs a signal indicating the status. For example, it may only send a signal when the setpoint is reached. Other sensors may provide continual readings of condition, say vibration frequency. In those cases, a setpoint may be stored in memory for access by program control software.

Certain embodiments may allow for dynamic parameter settings. In these embodiments, the parameters may be sent wirelessly to the flying vehicle using the on-board flight processors communications system. In certain embodiments, new sensor threshold values can be transmitted to flying vehicle through the vehicle's communication system. In other embodiments, real time sensor information may be sent to a remote station for analysis and new sensor parameter setpoint information may be transmitted to the flying vehicle. Dynamic parameter setting allows for programmatic control over the setpoint parameters either before or during flight.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Operation

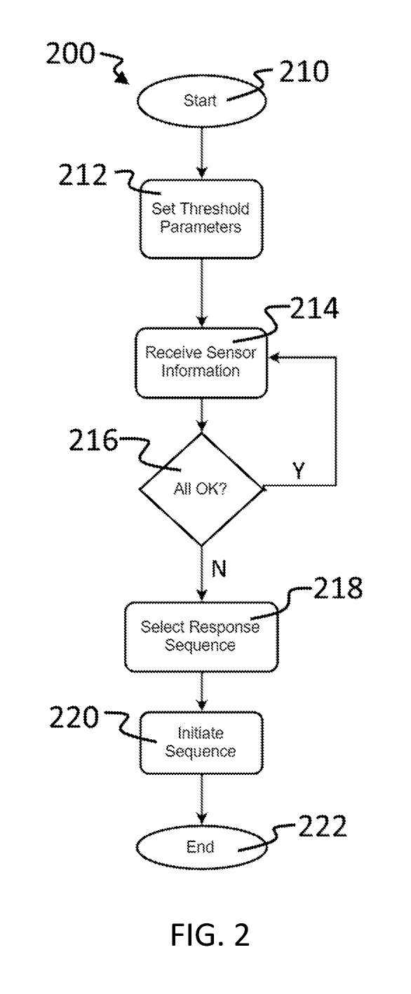

FIG. 2 illustrates a flowchart illustrating steps that may be used in certain embodiments of the present disclosure. In FIG. 2 a method begins at a flow label Start 210 and proceeds to a step 212.

At the step 212 threshold parameters are set for the sensors. These threshold parameters include values which are forerunners of any emergency or abnormal situations that may arise in flight. For example, and without limitation, a vibration sensor's setpoint may be set for a specific frequency, displacement, or velocity. Exceeding these setpoints may be indicative of a failure in one of the systems. The setpoint may be set on the sensors itself, or programmed into memory for access by the on-board flight processor. Setting threshold parameters may occur before or during flight if dynamic parameters setting is used.

At a step 214 the on-board flight processor receives information from one or more sensors.

At a step 216 the information from the sensors is evaluated to determine if there is a cause for any emergency or fault procedures to be effectuated. This evaluation may include by simply testing for a yes/no signal from a sensor, comparing the sensor information to a setpoint stored in memory, performing calculations on raw sensor data to determine a fault condition, and similar testing procedures.

If no emergency condition is determined, then the process moves back to a step 214. If a fault or emergency condition is determined, then the method moves to a step 218

At a step 218 a response sequence is selected. The selection is based on the type of emergency or fault detected or, in some embodiments, the sensor information. For example, and without limitation, if a motor fault is detected, a response sequence may be to increase power to other motors to maintain level flight.

At a step 220 the response sequence is initiated. Continuing with the example above, the sequence may include increasing power to other motors to maintain level flight, and include a gradually slowing of power to the motors to guide the flying vehicle to a soft landing. The lost thrust and torque owing to the malfunction are automatically redistributed to a correctly operating opposite pair of electric motors symmetrically placed against the center of gravity and the longitudinal axis of the quadcopter, allowing for a controlled emergency landing of the flying vehicle.

At a flow label 222 the method ends.

### Exemplary Operations

In some embodiments, the aforementioned method may operate to safely land the multicopter during a flight emergency. In an exemplary embodiment, in the event of emergency (or abnormal) situations on one of the independently operating electric motors or rotors, such as a breakdown of the rotor or a motor failure, the error signal from the faulty motor or main rotor is sensed and instantly transmitted to the on-board flight processor. The on-board flight processor selects the appropriate response sequence according to a set program menu established before the flight started (or dynamically during flight). Once the corresponding malfunction is ascertained, the processor issues a command (or control signal) to disconnect the failed motor and other motors that may interfere with the even redistribution of lifting power. The sequence may then increase the thrust to other motors. In a quadcopter example, shutting down two motors converts the flying machine into a bi-copter. The remaining electric motors that are working properly may have maximum power applied and balanced to ensure the horizontal stabilization of the multicopter in the air. The sequence may then provide a smooth landing by decreasing overall power to the motors in a controlled manner.

The redistribution of lifting power of a multicopter may entail stopping power to a rotor diagonally across the center-of-gravity of the multicopter from the failed rotor. A failed rotor stops providing lift, so a rotor on the opposite side of the flying vehicle will, by continuing to apply lift, will cause the flying vehicle to pitch or roll. The redistribution of lift may therefore stop all power to a rotor opposite a failed rotor. Moreover, power to any remaining rotors may be increased swiftly to maintain altitude of the flying vehicle after the loss of two or more rotors. Redistribution may also be aided by the use of on-board level sensors to provide near real-time feedback to the processor.

In some embodiment emergency stability control may be effectuated by transmitting to the on-board flight processor the extreme threshold parameters that are precursors of an emergency or abnormal situation. This allows for a quadcopter to be operated as a bicopter by command signals from the on-board flight processor and compensate for the losses of the other two rotor motors. This may entail stabilizing the bicopter horizontally by uniformly distributing the thrust (doubling the thrust) to the two rotor motors operating properly. In some embodiments reserve power may be supplied by a secondary power source to allow for rapid ramp-up of current supplied to motors or as a backup source of power in the event of failure.

In alternative embodiments, the on-board processor may record flight path information and in the event of a failure condition, returning to the proper flight path may be part of the response sequence.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

I claim:

1. A flying vehicle including:
a plurality of motors, each of said motors coupled to a rotor and a motor controller, said plurality of motors including at least two motors disposed substantially on opposite sides of the center of gravity of the flying vehicle and at least two motors disposed substantially orthogonally thereto;
at least one sensor coupled to one of either the motors or the rotors, said sensor operative to sense an operating characteristic of the rotor or motor;
a processor, said processor coupled to a memory and to said motor control circuitry and said sensors, said processor operable to;
receive a signal from the sensor;
compare the signal to a predetermined operational characteristic;
determine a predetermined operational procedure in response to the signal, and
alter the operating characteristics of one or more motors,
wherein the operational procedure effectuates mitigation of the failure condition.

2. The vehicle of claim 1 wherein the sensor includes at least one of a level sensor, a vibration sensor, or a motor current sensor.

3. The vehicle of claim 1 wherein the predetermined operational procedure includes removing power from one of said motors opposite the center of gravity of a failed motor or rotor and increasing power to a predetermined other motor.

4. The vehicle of claim 1 wherein said sensor is operable to sense the operating characteristic of the rotor or motor in response to a setpoint.

5. The vehicle of claim 1 where the processor is further operable to compare the sensor signal to a setpoint.

6. A flying device including:
a first motor-driven rotor, said first motor-driven rotor coupled to a first sensor, said first sensor operable to sense a failure in the first motor-driven rotor;
a first motor control circuit operable to supply power to the first motor-drive rotor under control of a processor;
a second motor-driven rotor, said second motor-driven rotor coupled to a second sensor, said second sensor operable to sense a failure in the second motor-driven rotor;
a second motor control circuit operable to supply power to the second motor-drive rotor under control of a processor;
said processor coupled to a memory, the sensor, and input/output for receiving preprogrammed fault parameters;
said memory including non-transitory program instruction operable to direct the processor to perform a method including:
receiving a signal from the first sensor;
comparing the signal to a predetermined value;
determining a predetermined operational procedure in response to the comparing, and
altering the operating characteristics of first and second motor-driven rotor,
wherein the signal indicates a failure condition and the operational procedure effectuates mitigation of the failure condition.

7. The device of claim 6 wherein said altering the operating characteristics includes removing power from the first motor-driven rotor and increasing power to the second motor-driven rotor.

8. The device of claim 7 wherein the first motor-driven rotor is disposed substantially opposite the center of gravity of a failed motor.

9. A flying vehicle including:
a first pair of electrically driven propellers, said propellers disposed on the flying vehicle on substantially opposite sides of the center of gravity;
a second pair of electrically driven propellers, said propellers disposed substantially orthogonally to the first pair of electrically driven propellers and on substantially opposite sides of the center of gravity;
a first set of sensors coupled to the first set of electrically driven propellers;
a sense circuit, said sense circuit operable to receive signals from the first set of sensors, compare those signals to a predetermined value and power down the first pair of electrically driven propellers in response to the comparison.

10. The vehicle of claim 9 wherein the sense circuitry includes a processor, said processor coupled to memory, said memory including non-transitory program instruction directing the processor to perform a method including:
receiving sensor information;
comparing the sensor information to a setpoint;
selecting a predetermined operational procedure in response to said comparing, and
executing the operational procedure.

11. The vehicle of claim 10 wherein the operational procedure includes:
turning off the first pair of electrically driven propellers;
receiving altitude information,
and increasing power to the second pair of electrically driven propellers to maintain altitude.

12. The vehicle of claim 10 wherein the operational procedure includes gradually removing power from all electrically driven propellers to effectuate a safe landing for the vehicle.

13. The vehicle of claim 9 wherein the sensors include at least one of either an altimeter, a tachometer, a vibration sensor or a LIDAR proximity sensor.
